(19) United States
(12) Patent Application Publication
(10) Pub. No.: US 2010/0200381 A1
(43) Pub. Date: Aug. 12, 2010

(54) KEY MODULE

(76) Inventor: Shih-Yuan Kuo, Taipei Hsien (TW)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/368,307

(22) Filed: Feb. 10, 2009

(51) Int. Cl. H01H 9/00

(52) U.S. Cl. 200/314

(57) ABSTRACT

A key module includes a circuit board, at least a key, at least a light emitting unit and a light guide film. The key is disposed on the circuit board. The light emitting unit is coupled to the circuit board for providing a light source. The light guide film is disposed between the circuit board and the key for guiding the light source provided by the light emitting unit to the key. In addition, the material of the light guide film is a flexible light guide material.

### BACKGROUND OF THE INVENTION

1. Field of the Invention

The present invention relates to a key module, and more particularly, to a key module having a light guide film made of a flexible light guide material.

2. Description of the Prior Art

A light guide film, which is one of the most important components in a key module, is used for guiding the light emitted from a light emitting unit to the key surface. In current hand-held apparatus, a light guide film in the key module is commonly made of polyester (PET) or polycarbonate (PC); however, a PET/PC light guide film has lower luminance. While high luminance is desired, it requires thickening the light guide film, which is likely to result in a poor key pressure.

### SUMMARY OF THE INVENTION

It is therefore one of the objectives of the present invention to provide a key module having a light guide film made of a flexible light guide material (e.g., a silicone compound) having a high luminance and flexibility, that is capable of providing a good key pressure, in order to solve the above-mentioned problem.

According to an exemplary embodiment of the present invention, a key module is provided. The key module comprises a circuit board; at least a key, which is disposed on the circuit board; at least a light emitting unit, which is coupled to the circuit board and is utilized for providing a light source; and a light guide film, which is disposed between the circuit board and the key and is utilized for guiding the light source provided by the light emitting unit to the key. In addition, the material of the light guide film is a flexible light guide material.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a key module according to an embodiment of the present invention.

FIG. 2 is a luminance to key position diagram of the key modules respectively having a PC light guide film and silicone compound light guide film.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

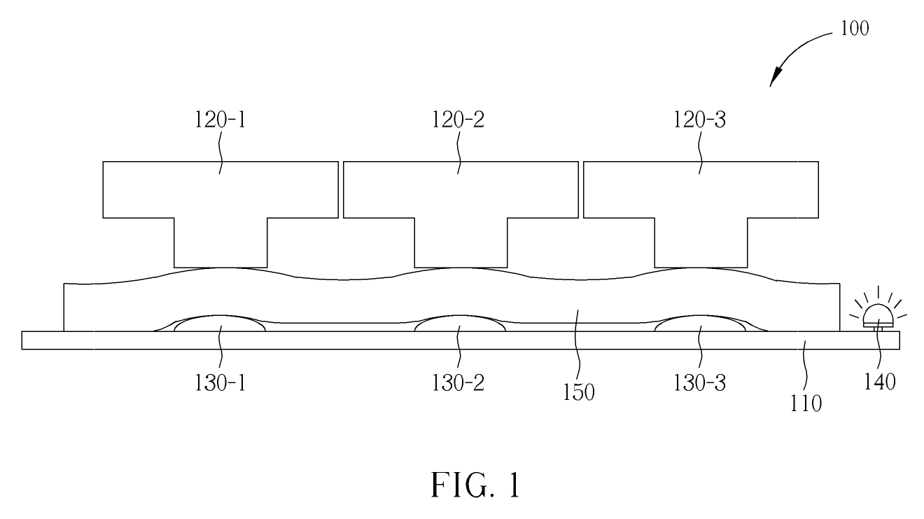

Please refer to FIG. 1. FIG. 1 is a schematic diagram illustrating a key module 100 according to an embodiment of the present invention. As shown in FIG. 1, the key module 100 comprises a circuit board 110, a plurality of keys 120-1, 120-2, 120-3, a plurality of elastic structures 130-1, 130-2, 130-3, a light emitting unit 140 and a light guide film 150. The keys 120-1˜120-3, the elastic structures 130-1˜130-3 and the light emitting unit 140 are all disposed on the circuit board 110. The elastic structures 130-1˜130-3 respectively correspond to the keys 120-1˜120-3, and provide a corresponding key pressure while the keys 120-1˜120-3 are pressed. The light emitting unit 140 is used for providing a light source. The light guide film 150 is disposed between the keys 120-1˜120-3 and the elastic structures 130-1˜130-3, and is used for guiding the light source provided by the light emitting unit 140 to the keys 120-1˜120-3. In addition, the material of the light guide film 150 is a flexible light guide material. Further description of the key module 100 is detailed as follows. In this embodiment, the key module 100 is disposed in a hand-held apparatus (e.g., a mobile phone); however, this description is merely for greater clarity of understanding, and should not be taken as limiting the present invention.

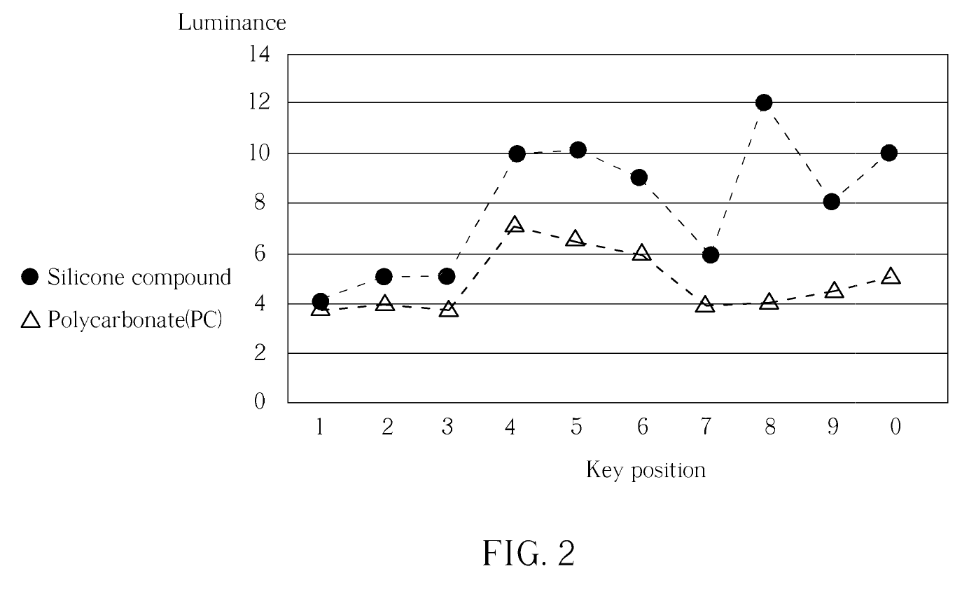

As mentioned above, the material of the light guide film 150 is a flexible light guide material, whose hardness and tensile strength are greater than 45 (in Shore hardness) and 5.5*10⁶ Pa respectively. For example, the material of the light guide film 150 can be a silicone compound. Its hardness ranges between 50 and 75 (e.g., 60) (in Shore hardness), and its tensile strength ranges between 6*10⁶ and 8*10⁶ Pa (e.g., 6.7*10⁶ Pa). Compared to the prior art, the luminance of the silicone compound light guide film is as much as 5.5 times that of a PC light guide film. Please refer to FIG. 2. FIG. 2 is a luminance to key position diagram of the key modules having a PC light guide film and silicone compound light guide film, respectively. As seen from FIG. 2, the silicone compound light guide film has a higher luminance than the PC light guide film, and its flexible characteristic is capable of providing a better key pressure. In addition, there are diverse processes for manufacturing silicone compound light guide films. For example, the silicone compound light guide film can be manufactured by liquid injection molding, coating or compound molding. The diverse processes make it more flexible to design other components, such as optical microstructures, in the key module.

Please note that, in the above-mentioned embodiment, the material of the light guide film 150 is a silicone compound. This is, however, for illustrative purposes and not a limitation of the present invention. In other embodiments, the materials of the light guide film 150 can be any other flexible light guide materials depending on design requirements.

Please note that, in the above-mentioned embodiment, the hardness of the light guide film 150 ranges between 50 and 75, and the tensile strength of the light guide film 150 ranges between 6*10⁶ and 8*10⁶ Pa. This is also, however, for illustrative purposes and not a limitation of the present invention. In practice, the hardness of the light guide film is greater than 45, and the tensile strength of the light guide film is greater than 5.5*10⁶ Pa. This alternative design also falls within the scope of the present invention.

Please note that, in the above-mentioned embodiment, the key module 100 comprises the elastic structures 130-1˜130-3. This is also, however, for illustrative purposes and not a limitation of the present invention. In other embodiments, the key module can have not any elastic structure.

Please note that, in the above-mentioned embodiment, the key module 100 has only one light emitting unit 140. This is, however, for illustrative purposes and not a limitation of the present invention. In other embodiments, the key module can have a plurality of light emitting units, which are disposed on only one side or both sides of the circuit board.

Those skilled in the art will readily observe that numerous modifications and alterations of the device and method may be made while retaining the teachings of the invention.

What is claimed is:

1. A key module, comprising:
a circuit board;
at least a key, disposed on the circuit board;
at least a light emitting unit, coupled to the circuit board, for providing a light source; and
a light guide film, disposed between the circuit board and the key for guiding the light source provided by the light emitting unit to the key;
wherein a material of the light guide film is a flexible light guide material.

2. The key module of claim 1, wherein the material of the light guide film is a silicone compound.

3. The key module of claim 1, wherein at least an elastic structure is disposed on a surface of the circuit board for providing a key pressure, and a surface of the elastic structure is covered by the light guide film.

4. The key module of claim 1, wherein the light guide film is formed by liquid injection molding, coating or compound molding.

5. The key module of claim 1, wherein a hardness of the light guide film is greater than 45 (in Shore hardness).

6. The key module of claim 1, wherein the hardness of the light guide film ranges between 50 and 75 (in Shore hardness).

7. The key module of claim 1, wherein a tensile strength of the light guide film is greater than 5.5*10⁶ Pa.

8. The key module of claim 1, wherein the tensile strength of the light guide film ranges between 6*10⁶ and 8*10⁶ Pa.
